(19) United States
(12) Patent Application Publication
(10) Pub. No.: US 2015/0069906 A1
(43) Pub. Date: Mar. 12, 2015

(54) CIRCUIT ARRANGEMENT, LIGHTING UNIT FOR A VEHICLE AND METHOD FOR DRIVING SEMICONDUCTOR LIGHTING ELEMENTS

(71) Applicant: OSRAM GmbH, Muenchen (DE)

(72) Inventor: Peter Niedermeier, Muenchen (DE)

(21) Appl. No.: 14/374,231

(22) PCT Filed: Jan. 15, 2013
(86) PCT No.: PCT/EP2013/050685

§ 371 Date: Jul. 24, 2014

(30) Foreign Application Priority Data
Feb. 1, 2012 (DE) 10 2012 201 415.2

(51) Int. Cl. H05B 33/08; B60Q 1/00

(52) U.S. Cl. CPC H05B 33/0803; B60Q 1/00
USPC 315/77; 315/185 R

(57) ABSTRACT

Various embodiments relate to a circuit arrangement, including a plurality of semiconductor lighting elements connected in series, a converter for driving the semiconductor lighting elements, and a control unit, with the aid of which the semiconductor lighting elements connected in series can at least partially be bridged by means of drivable electronic switches, wherein the converter can be switched between a first operating mode and a second operating mode with the aid of the control unit, and wherein the converter can be operated as a step-up converter in the first operating mode and the converter can be operated as a step-down converter in the second operating mode.

### RELATED APPLICATIONS

The present application is a national stage entry according to 35 U.S.C. §371 of PCT application No.: PCT/EP2013/050685 filed on Jan. 15, 2013, which claims priority from German application No.: 102012201415.2 filed on Feb. 1, 2012, and is incorporated herein by reference in its entirety.

### TECHNICAL FIELD

Various embodiments relate to a circuit arrangement, to a lighting unit for a vehicle and to a method for driving semiconductor lighting elements.

### BACKGROUND

The use of light-emitting diodes connected in series, some of which being temporarily bridged and therefore turned off, requires a converter which can supply both a higher and a lower output voltage in comparison with its input voltage.

For example, different lighting functionalities of a vehicle are provided by a rear light. The rear light may for example include a stop lamp, a position lamp, a turn signal light, a fog lamp and/or a reversing lamp. Lighting properties may furthermore be provided direction-dependently by the rear light.

For example, so-called step-up converters and step-down converters (as well as combinations of the two) are known for the conversion of voltages. Examples of converters which can provide both a step-up functionality and a step-down functionality are the SEPIC converter or the CUK converter.

A disadvantage in this case is that a different number of light-emitting diodes are activated depending on the functionality of a rear light. This gives rise to different operating voltages, which may sometimes be higher and sometimes lower than a supply voltage in the vehicle. A plurality of converters, which adapt the supply voltage to the level of the operating voltage, are therefore required.

### SUMMARY

Various embodiments provide an efficient solution for operating a lighting unit, in which a single converter that provides a suitable operating voltage for semiconductor lighting elements of the lighting unit is preferably provided.

A circuit arrangement is proposed,
having a plurality of semiconductor lighting elements connected in series,
having a converter for driving the semiconductor lighting elements,
having a control unit, with the aid of which the semiconductor lighting elements connected in series can at least partially be bridged by means of drivable electronic switches,
wherein the converter can be switched between a first operating mode and a second operating mode with the aid of the control unit, and
wherein the converter can be operated as a step-up converter in the first operating mode and the converter can be operated as a step-down converter in the second operating mode.

The converter is, in particular, a DC/DC converter. The converter can be operated as a step-up converter in a first circuit configuration and as a step-down converter in a second circuit configuration. By means of the control unit, it is possible to switch between the circuit configurations (operating modes) of the converter. This is preferably done by means of electronic switches, which are driven by the control unit.

Transistors, in particular bipolar or field-effect transistors, may be used for the electronic switches. In particular, MOSFETs may be used. Correspondingly, other switches which are electronically drivable, for example by said control unit (optocouplers, relays, etc.), are also possible.

The semiconductor lighting element may, in particular, be a light-emitting diode.

It is one refinement that the semiconductor lighting elements connected in series are grouped, each group including at least one of the semiconductor lighting elements.

It is another refinement that, as a function of a control signal, the control unit activates at least one group of the semiconductor lighting elements and drives the converter according to the operating mode suiting the activated semiconductor lighting elements.

Thus, the number of semiconductor lighting elements for which a suitable voltage must be provided may be dictated by the selected group. As a function of the level of the input voltage, the control unit detects the extent to which the voltage is to be adapted for the semiconductor lighting elements to be activated, and controls the converter accordingly.

It is also an option that a plurality of groups of semiconductor elements are activated simultaneously or almost simultaneously (for example in time division multiplexing operation). In the case of a rear light of a vehicle, for example, a turn signal, a reversing lamp and a low beam lamp may be turned on simultaneously.

It is also one refinement that each group of the semiconductor lighting elements corresponds to a lighting function of a vehicle.

In this case, a multiplicity of different lighting functions may be achieved: a position lamp, turn signal, low beam lamp, fog lamp, reversing lamp, etc.

In particular, it is one refinement that that operating mode with the aid of which a suitable supply for the activated semiconductor lighting elements is possible is set as associated with the activated semiconductor lighting elements.

It is furthermore one refinement that the control unit includes a microcontroller, a processor or a controller, with the aid of which, as a function of predetermined input signals, the semiconductor lighting elements can be driven and the operating mode of the converter can be set.

It is a next refinement that the converter includes at least an inductor, a diode and a further electronic switch, these components enabling a functionality of the converter as a step-up converter or step-down converter according to the operating mode of the converter, and the further electronic switch being drivable by the control unit in order to operate the converter.

The above object is also achieved with the aid of a lighting unit for a vehicle, including the circuit arrangement as described herein.

It is one arrangement that the lighting unit is a rear light, a headlamp or another light of a vehicle.

The object mentioned above is furthermore achieved by means of a method for driving a plurality of semiconductor lighting elements connected in series,
wherein, by means of a control unit, the semiconductor lighting elements connected in series can be partially bridged by means of drivable electronic switches,
wherein a converter for driving the semiconductor lighting elements can be switched between a first operating mode and a second operating mode with the aid of the control unit, and
wherein the converter can be operated as a step-up converter in the first operating mode and the converter can be operated as a step-down converter in the second operating mode.

One embodiment consists in that the converter is operated in the first operating mode or second operating mode as a function of the voltage required for driving the semiconductor lighting elements.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows an exemplary circuit arrangement to illustrate the present approach for implementing a B2B mode and a B2G mode with a single converter in different circuit configurations; and

FIG. 2 shows a schematic circuit diagram for the driving of a lighting unit of a vehicle.

### DETAILED DESCRIPTION

The following detailed description refers to the accompanying drawing that show, by way of illustration, specific details and embodiments in which the disclosure may be practiced.

Light-emitting diodes connected in series will be used by way of example below in a rear light of a vehicle. The solution proposed here can correspondingly be used in other lighting applications, or lighting units. In particular, semiconductor lighting elements may be used. Each light-emitting diode may include at least one semiconductor lighting element, in which case a plurality of semiconductor lighting elements may also be connected in series and/or parallel with one another.

The light-emitting diodes connected in series are driven by a converter (also referred to as a switching regulator), which can be operated in a first operating mode and in a second operating mode. In the first operating mode, the converter is operated as a step-up converter, and in the second operating mode the converter is operated as a step-down converter. The first operating mode is also referred to as a B2G mode, and the second operating mode is also referred to as a B2B mode (B2B: boost-to-battery, i.e. a step-up functionality relative to the potential of the supply voltage, or the battery; B2G; boost-to-ground, i.e. a step-up functionality relative to ground).

In this case, it is advantageous that only a single converter is to be dimensioned with its regulating behavior and with the associated components. With this one converter, it is possible to generate voltages which are either higher or lower than the supply voltage.

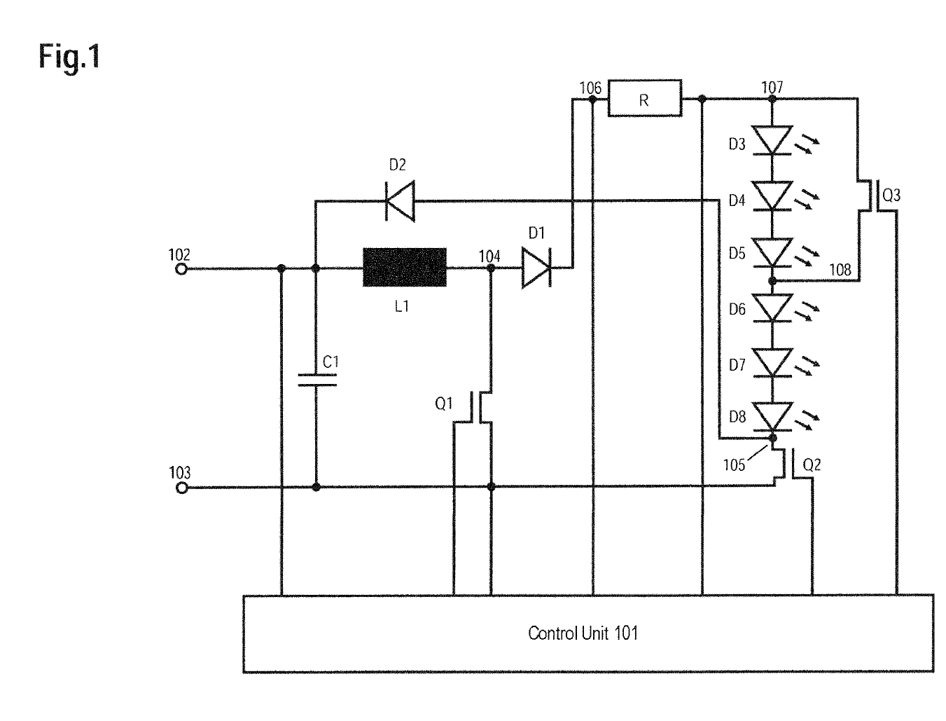

FIG. 1 shows an exemplary circuit arrangement to illustrate the present approach for implementing a B2B mode and a B2G mode.

One terminal 102 is coupled for example to a 12 V input voltage and one terminal 103 is coupled to 0 V. The terminal 102 is connected via an inductor L1 to a node 104.

The node 104 is connected to the drain terminal of an n-channel MOSFET Q1 and to the anode of a diode D1. The cathode of the diode D1 is connected to a node 106. The node 106 is connected by a resistor R to a node 107. The node 107 is connected via three series-connected light-emitting diodes D3 to D5 to a node 108, the cathodes of the light-emitting diodes D3 to D5 being oriented in the direction of the node 108. The node 108 is connected to the source terminal of an n-channel MOSFET Q3. The node 108 is furthermore connected via the series-connected light-emitting diodes D6 to D8 to a node 105, the cathodes of the light-emitting diodes D6 to D8 being oriented in the direction of the node 105. The node 107 is connected to the drain terminal of the MOSFET Q3.

The node 105 is connected to the drain terminal of an n-channel MOSFET Q2. Furthermore, the node 105 is connected via a diode D2 to the terminal 102, the cathode of the diode D2 being oriented in the direction of the terminal 102.

The source terminal of the MOSFET Q1 is connected to the terminal 103. The source terminal of the MOSFET Q2 is likewise connected to the terminal 103. A capacitor C1 is arranged between the terminal 102 and the terminal 103.

A control unit 101 is furthermore provided, with the aid of which the gate terminals of the MOSFETs Q1, Q2 and Q3 can be driven. Furthermore, the control unit 101 is connected to the terminal 102, the node 106 and the node 107. With the aid of the connections to the nodes 106 and 107, the current flowing through the resistor R, or the voltage drop across this resistor R, can be determined by the control unit 101. The resistor R may therefore also be referred to as a shunt or measurement resistor. By virtue of a connection to the terminal 102, the level of the input voltage can be determined by the control unit 101.

By means of the components inductor L1, diode D1 and MOSFET Q1, a step-up converter is provided. When all the light-emitting diodes D3 to D8 and the MOSFET Q2 are activated, then for a functional capability of the light-emitting diodes D3 to D8 it is necessary for the sum of the on-state voltages of the light-emitting diodes D3 to D8 to be greater than the input voltage at the terminal 102. The converter correspondingly acts as a step-up converter and provides a voltage suitable for the light-emitting diodes D3 to D8. The current for the light-emitting diodes D3 to D8 may, for example, be determined with the aid of the resistor R.

In a second operating mode, some of the light-emitting diodes are intended to be bridged. In the present example according to FIG. 1, these are the light-emitting diodes D3 to D5, which can be bridged, or short-circuited, by activating the MOSFET Q3. In the second operating mode, only the light-emitting diodes D6 to D8 are therefore active, and these need to be supplied with a lower voltage than the input voltage of 12 V. To this end, the converter is operated as a step-down converter.

In this case, the MOSFET Q2 may be switched off (i.e. the control unit 101 drives the MOSFET Q2 via its gate terminal in such a way that it does not conduct). The output voltage receives the input voltage as a reference (B2B mode). The MOSFET Q1—driven by means of the control unit 101—operates as a switch of a step-down converter.

With just a single converter, it is therefore possible to achieve driving of different lighting units (here, in the first case, the series circuit including the light-emitting diodes D3 to D8, and in the second case the series circuit including the light-emitting diodes D6 to D8).

One possible application is a lighting unit in a vehicle, for example a rear light, which is intended to shine with a different strength depending on predetermined situations (for example with more or fewer active light-emitting diodes).

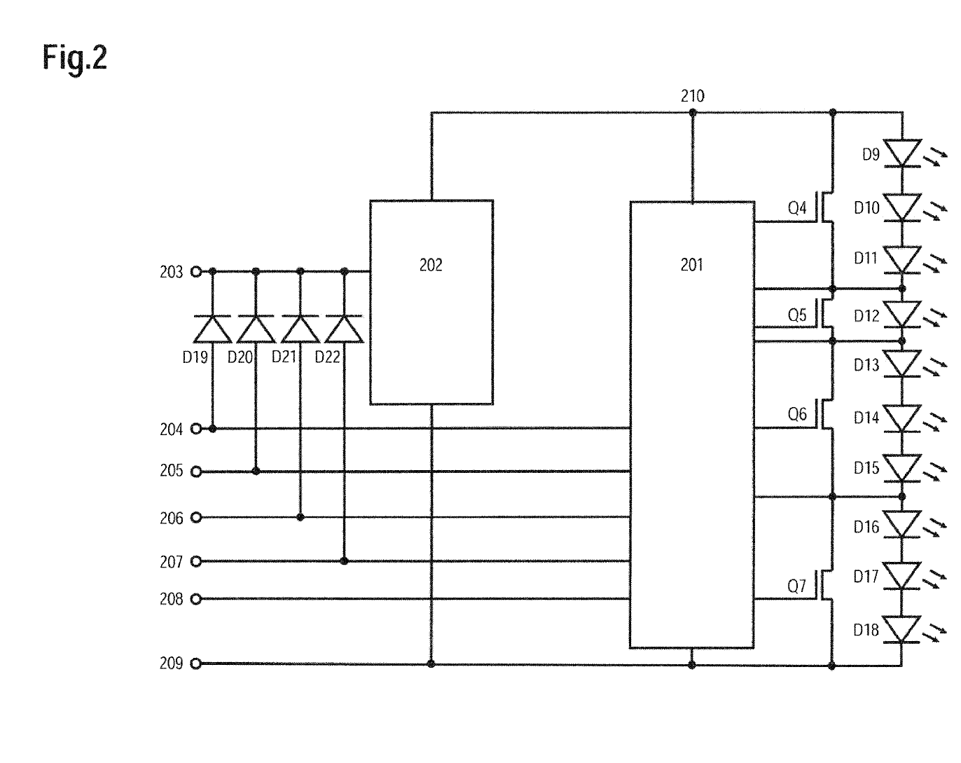

FIG. 2 shows a schematic circuit diagram for the driving of a lighting unit of a vehicle including the light-emitting diodes D9 to D18, the light-emitting diodes D9 to D11 representing a stop lamp, the light-emitting diode D12 representing a tail light, the light-emitting diodes D13 to D15 representing a turn signal light and the light-emitting diodes D16 to D18 representing a tail light or a fog lamp.

Depending on the use, the following light-emitting diodes may be short-circuited as follows by electronic switches (for example in each case an n-channel MOSFET):
D9 to D11 (group 1): MOSFET Q4;
D12 (group 2): MOSFET Q5;
D13 to D15 (group 3): MOSFET Q6;
D16 to D18 (group 4): MOSFET Q7.

The gate terminals of the MOSFETs Q4 to Q7 are driven by a control unit 201. The control unit 201 may involve any desired drive logic, for example a controller device of a vehicle. The control unit 201 may also be configured as a part of the lighting unit, for example of the rear light.

The light-emitting diodes D9 to D18 can be short-circuited, or selectively driven, according to the groupings (groups 1 to 4) mentioned above by way of example. By means of the control unit 201, it is thus possible for none, only one or several of the groups 1 to 4 to be active. For example, it is thus possible to produce a stop lamp becoming brighter in stages (for example as a function of the deceleration of the vehicle) and/or a turn signal, a low beam lamp, etc. To this end—as represented in FIG. 2—the nodes between the groups 1 to 4 are preferably connected to the control unit 201.

A converter 202, in particular a DC/DC converter, is connected to a node 210, which is also connected to the first light-emitting diode D9 of the series-connected light-emitting diodes and to the control unit 201. The converter 202 is connected to a terminal 203, for example of a supply voltage at the level of 12 V, as well as to a terminal 209 (0 V). The terminal 209 is also connected to the control unit 201 and to the last light-emitting diode D18 of the light-emitting diodes connected in series.

A plurality of terminals 204 to 208 are furthermore provided, which are connected to the control unit 201. The terminals 204 to 208 provide, for example, the following input signals, which may lead to corresponding driving of the light-emitting diodes D9 to D18, or be used therefor:
terminal 204: stop lamp;
terminal 205: low beam lamp;
terminal 206: turn signal;
terminal 207: reversing lamp/fog lamp;
terminal 208: bus signal, for example CAN bus signal.

The terminals 204 to 208 are respectively connected via a diode D19 to D22 to the terminal 203 and therefore to the converter 202, the cathodes of the diodes D19 to D22 pointing in the direction of the terminal 203.

It should be pointed out here that each light-emitting diode D9 to D18 may respectively represent a lighting module having a plurality of semiconductor lighting elements.

It is therefore possible for the circuit arrangement according to FIG. 2 to be used as a rear lighting unit in a vehicle. It should be pointed out here that the embodiment explained is exemplary and may correspondingly be implemented in various ways. In the example mentioned above, one rear lighting unit (for example the one on the left) may include the reversing light and the other rear lighting unit (for example the one on the right) may include the fog lamp. In particular, the circuit arrangement may be part of a rear lighting unit. Naturally, the circuit arrangement may also be configured at least partially at a different position, for example in a central controller of the vehicle.

One advantage of the embodiment presented is that a rear lighting unit having a circuit arrangement can be used directly without additional adaptations of a central controller being necessary. For example, the CAN terminal 208 may be adapted in such a way that it operates with a previous communication interface of the vehicle. This approach has the advantage that it is merely necessary to dimension the converter with a corresponding regulating behavior and with the necessary components, and the lighting unit can be used flexibly, for example in a vehicle.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCES

101 control unit
102 terminal (for example input voltage at the level of +12 V)
103 terminal (for example 0 V)
104 node
105 node
106 node
107 node
108 node
201 control unit
202 converter
203 terminal (for example input voltage at the level of +12 V)
204-208 terminal (input signals for lighting functions)
209 terminal (for example 0 V)
210 node
L1 inductor (for example coil)
C1 capacitor
R resistor
Q1-Q7 electronic switch (for example n-channel MOSFET)
D1, D2 diode
D3-D18 semiconductor lighting element (for example light-emitting diode)
D19-D22 diode

1. A circuit arrangement, comprising:
a plurality of semiconductor lighting elements connected in series,
a converter for driving the semiconductor lighting elements, and
a control unit, with the aid of which the semiconductor lighting elements connected in series can at least partially be bridged by means of drivable electronic switches,
wherein the converter can be switched between a first operating mode and a second operating mode with the aid of the control unit, and
wherein the converter can be operated as a step-up converter in the first operating mode and the converter can be operated as a step-down converter in the second operating mode.

2. The circuit arrangement as claimed in claim 1, wherein the converter is a DC/DC converter.

3. The circuit arrangement as claimed in claim 1, wherein the semiconductor lighting elements connected in series are grouped, each group comprising at least one of the semiconductor lighting elements.

4. The circuit arrangement as claimed in claim 3, wherein, as a function of a control signal, the control unit activates at least one group of the semiconductor lighting elements and drives the converter according to the operating mode suiting the activated semiconductor lighting elements.

5. The circuit arrangement as claimed in claim 4, wherein each group of the semiconductor lighting elements corresponds to a lighting function of a vehicle.

6. The circuit arrangement as claimed in claim 4, wherein that operating mode with the aid of which a suitable supply for the activated semiconductor lighting elements is possible is set as associated with the activated semiconductor lighting elements.

7. The circuit arrangement as claimed in claim 1, wherein the control unit comprises a microcontroller, a processor or a controller, with the aid of which, as a function of predetermined input signals, the semiconductor lighting elements can be driven and the operating mode of the converter can be set.

8. The circuit arrangement as claimed in claim 1, wherein the converter comprises at least an inductor, a diode and an electronic switch, these components enabling a functionality of the converter as a step-up converter or step-down converter according to the operating mode of the converter, and the electronic switch being drivable by the control unit in order to operate the converter.

9. A lighting unit for a vehicle, comprising a circuit arrangement
the circuit arrangement, comprising:
a plurality of semiconductor lighting elements connected in series,
a converter for driving the semiconductor lighting elements, and
a control unit, with the aid of which the semiconductor lighting elements connected in series can at least partially be bridged by means of drivable electronic switches,
wherein the converter can be switched between a first operating mode and a second operating mode with the aid of the control unit, and
wherein the converter can be operated as a step-up converter in the first operating mode and the converter can be operated as a step-down converter in the second operating mode.

10. The lighting unit as claimed in claim 9, wherein the lighting unit is a rear light, a headlamp or another light of a vehicle.

11. A method for driving a plurality of semiconductor lighting elements connected in series,
wherein, by means of a control unit, the semiconductor lighting elements connected in series can be partially bridged by means of drivable electronic switches,
wherein a converter for driving the semiconductor lighting elements can be switched between a first operating mode and a second operating mode with the aid of the control unit, and
wherein the converter can be operated as a step-up converter in the first operating mode and the converter can be operated as a step-down converter in the second operating mode.

12. The method as claimed in claim 11, wherein the converter is operated in the first or second operating mode as a function of the voltage required for driving the semiconductor lighting elements.
